(19) United States
(12) Patent Application Publication
(10) Pub. No.: US 2014/0024007 A1
(43) Pub. Date: Jan. 23, 2014

(54) PORTAL/DASHBOARD INTERFACE FOR TEACHER/STUDENT RELATIONSHIP MANAGEMENT AND TRADITION PRESERVATION WEBSITE

(71) Applicant: Lakshman Mahadevan, Cordova, TN (US)

(72) Inventor: Lakshman Mahadevan, Cordova, TN (US)

(21) Appl. No.: 13/551,665

(22) Filed: Jul. 18, 2012

(51) Int. Cl. G09B 5/00

(52) U.S. Cl. 434/350

(57) ABSTRACT

A virtual studio for managing the relationship between a teacher and their students where the teacher uses multiple customizable portals to communicate with and manage their students. The teacher is able to customize the portal on a per student basis. The virtual studio also enables the teacher to promote students to perform other roles in the studio and includes a comprehensive invoicing feature for billing purposes. The virtual studio also helps teachers share their lessons with other virtual studios.

### BACKGROUND OF THE INVENTION

The present invention relates to teaching and, more particularly, to a dashboard interface for managing a teacher/student relationship.

Existing virtual studios are limited in hierarchical management and functionality. A few competitors offer solutions that allow teachers to share lessons online, but most focus on the individual lesson and the accounting functions associated with teacher/student relationships.

Furthermore, existing systems focus on the delivery of lessons and accounting functionality. No existing methods focus on the hierarchical relationship that will allow a master to preserve their tradition through their students.

As can be seen, there is a need for a system that enables a teacher to manage the dynamic relationship between a teacher and a student, while preserving the teaching tradition of that particular teacher.

### SUMMARY OF THE INVENTION

In one aspect of the present invention, the method of implementing a virtual studio comprises a dashboard interface, multiple portals and a plurality of users where each user is assigned to a particular role, and the portals are used to dynamically manage a relationship between a teacher and their students.

These and other features, aspects and advantages of the present invention will become better understood with reference to the following drawings, description and claims.

### BRIEF DESCRIPTION OF THE DRAWINGS

FIG. 1 is a flowchart describing an exemplary embodiment of the invention.

FIG. 2 is a continuation of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a virtual studio whereby master teachers can manage their relationships with other studios, and amongst master teacher, associate teachers, teaching assistants and students.

The method allows for master teachers to share their lessons with other teachers (formerly their students) who start a studio with the website and have the ability to charge such studios for using their lessons. When any of the teachers share their lessons with their students, the master teacher has the ability to invoice that studio as well, thereby ensuring that that the master teacher receives royalty whenever their lessons are shared with other studios.

A master teacher is able to register on a website, and create a web link for their studio. The master teacher invites students to enroll using the web link. The students may then register for the site and are able to access various content provided by the teacher. A student is able to register for multiple courses.

In some embodiments of the present invention, master teacher can perform several operations on the website. These operations can include assigning associate teachers, promoting students to teaching assistants and sharing lessons with other studios.

When lesson plans are shared, the website can process invoicing between studios, if needed, for the sharing of lesson plans. The website can deter the copying of streaming media by, for example, hiding source links from the students. Students can upload media to the website such as videos of their practice sessions where other teachers may review and comment on the uploaded media.

In some embodiments of the present invention, the method could enable unique, configurable, collapsible portals. Additionally, a master teacher may view and configure the portals of their associate teachers, teaching assistants and students. The master teacher can also upload best practice video files, share links of interest and along with the lessons that have been uploaded, provide a view of their tradition and teaching techniques. Teachers can comment on sessions using the logger, which maintains a history of the student-teacher interaction. The logger can be extracted to a pdf file or text file and can also be viewed on a mobile device.

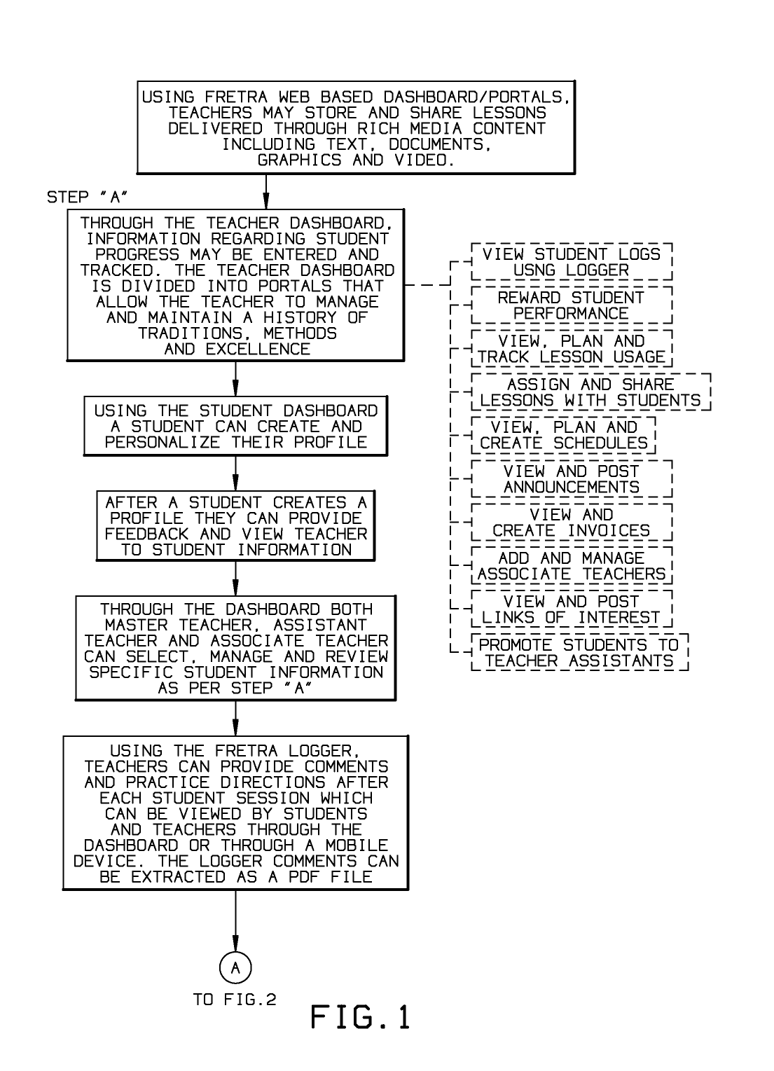

Referring to FIG. 1, teachers may use web based dashboard/portals to store and share lessons delivered through rich media content including text, documents, graphics, videos, and the like. A teacher may use the teacher dashboard where information regarding student progress may be entered and tracked. The teacher dashboard can be divided into portals that allow the teacher to manage and maintain a history of traditions, methods and excellence.

Using the student dashboard, a student can view lessons that the master/associate teacher or teaching assistant has assigned them. The student can read comments, read announcements, pay fees, upload practice files, log practice times, watch links of interest and best practice videos.

Through the dashboard, master teacher, teaching assistant and associate teacher can select, manage and review specific student information. The method also includes a logger which teachers can use to provide comments and practice directions after each student session. These comments and directions can be viewed by students and teachers through the dashboard or through a mobile device. The logger comments can be extracted into a file such as pdf, doc or txt file

In some embodiments of the present invention, the method includes additional functionality. This functionality includes enabling a logger that can log a teacher's comments over a period of time. The teacher or student can view the student logs using the logger. The teacher can review and reward student performance; create, assign and share lessons with students or studios; view, plan, create and edit schedules; post, edit and view announcements; view, edit and create invoices for teaching and lesson sharing; view, edit and post links of interest; and promote students to teacher assistants. A teacher may also upload and view student practice files.

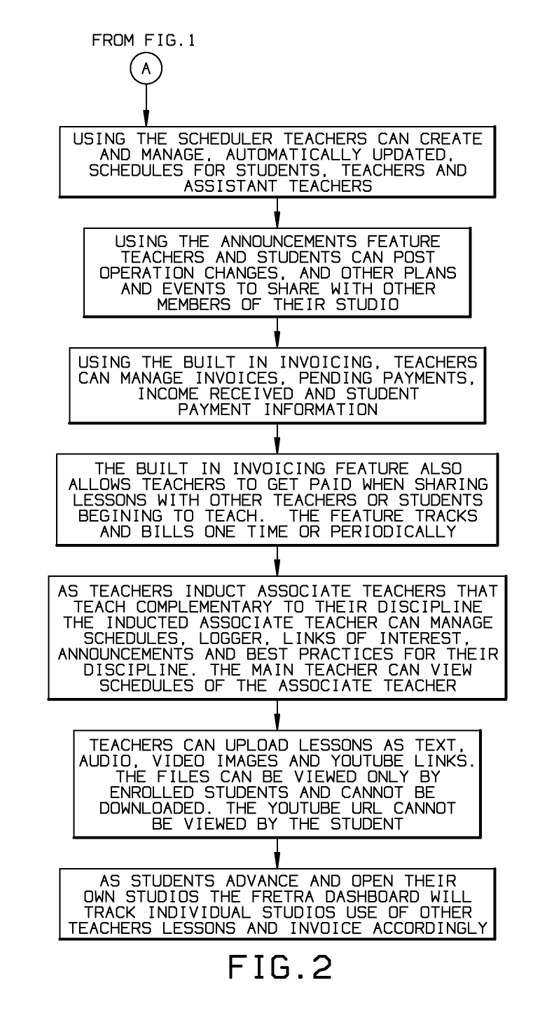

Referring to FIG. 2, teachers can create and manage automatically updated schedules for students, associate teachers and teaching assistants.

In some embodiments of the present invention, an announcements feature can be provided. With this feature, teachers and students can post operation changes, and other plans and events to share with other members of their studio.

In some embodiments of the present invention, the method could include built-in invoicing where teachers can manage invoices, pending payments, income received and payment information. The invoicing feature also allows teachers to get paid when sharing lessons with other teachers or students beginning to teach. The feature can track incurred charges and can produce bills for one time payments or periodic payments.

As master teachers of one discipline induct associate teachers that teach related disciplines, the inducted associate teacher can manage schedules, logger, links of interest, announcements and best practices for their discipline. The master teacher can view schedules of the associate teacher.

Teachers can upload lessons as media which would include text, audio, video such as those seen on [YOUTUBE] or the like. Typically, the files can be viewed only by enrolled students and cannot be downloaded. The teacher has the ability to hide the URL for any posted media from the student.

As students advance and open their own studios, the dashboard can track individual studios use of other teachers' lessons and invoice accordingly.

Functionality may be viewed through an online portal such as an exemplary portal configured at www.fretra.com. All of the modules interact to form a rich virtual studio session that may be employed to preserve the skill, art, cultures and methods of almost any discipline where these traditions are cherished. Teachers may sign up for their own studio, add students (an email is sent to each student with the web link of the teacher's studio asking them to sign up). Students are managed by the teacher and may be active or inactive. Lessons may be scheduled and virtually assigned, practice sessions reviewed, and feedback provided by the teacher.

Modules integrate across permissions and rights, scheduling, invoicing, lessons, announcements, logger (contains teacher comments over time—accessible via mobile app as well), practice sessions, rewards, associate teachers, lessons, best practices and student management portals.

The above-discussed embodiments include software that performs certain tasks. The software discussed herein may include script, batch, or other executable files. The software may be stored on a machine-readable or computer-readable storage medium, and is otherwise available to direct the operation of the computer system as described herein and claimed below. In one embodiment, the software uses a local or database memory to implement the data transformation and data structures so as to improve the generation of attribute-based rules. The local or database memory used for storing firmware or hardware modules in accordance with an embodiment of the invention may also include a semiconductor-based memory, which may be permanent, removable or remotely coupled to a microprocessor system.

The computer-based data processing system described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries.

It should be understood, of course, that the foregoing relates to exemplary embodiments of the invention and that modifications may be made without departing from the spirit and scope of the invention as set forth in the following claims.

What is claimed is:

1. A computer-based method of implementing a virtual studio, the method comprising:
registering a plurality of users with each user assigned to a particular role;
managing multiple customizable portals on a dashboard interface;
using the portals to dynamically manage a relationship between users.

2. The method of claim 1, further comprising providing input from a user to dynamically customize the portals to reflect their teaching preferences.

3. The method of claim 1, further comprising providing input from a user wherein the teacher can use the dashboard to upload lessons.

4. The method of claim 1, where a teacher manages announcements, lessons and payments.

5. The method of claim 1, where a teacher customizes the content of dashboard for at least one student.

6. The method of claim 1, wherein a user role includes that of a student, teaching assistant, associate teacher or master teacher.

7. The method of claim 1, wherein a master teacher changes the role of a second user, provided that the second user is not a master teacher.

8. The method of claim 1, wherein a master teacher can share lessons with other virtual studios on the system.
